(19) United States
(12) Patent Application Publication
(10) Pub. No.: US 2010/0290642 A1
(43) Pub. Date: Nov. 18, 2010

(54) SPEAKER CHARACTERISTIC CORRECTION DEVICE, SPEAKER CHARACTERISTIC CORRECTION METHOD AND SPEAKER CHARACTERISTIC CORRECTION PROGRAM

(76) Inventors: Tomomi Hasegawa, Kawasaki (JP); Yoshitomo Imanishi, Fujimi (JP)

Correspondence Address: NIXON & VANDERHYE, PC, 901 NORTH GLEBE ROAD, 11TH FLOOR, ARLINGTON, VA, 22203, US

(21) Appl. No.: 12/812,627

(22) PCT Filed: Jan. 17, 2008
(86) PCT No.: PCT/JP2008/050532

§ 371 Date: Jul. 13, 2010

(51) Int. Cl. H04B 15/00

(52) U.S. Cl. 381/94.1

(57) ABSTRACT

A speaker characteristic correction device obtains a first speaker information of a first speaker, obtains a first sound field characteristic at an evaluation point that is obtained by using the first speaker in advance, and obtains a second speaker parameter indicating a mechanical characteristic and an electric characteristic of a second speaker. Then, the speaker characteristic correction device calculates a correction characteristic based on the first speaker information and the second speaker parameter, and calculates the second sound field characteristic by applying the correction characteristic to the first sound field characteristic. Thereby, when the speaker type is changed, it is possible to easily calculate the sound field characteristic without performing the re-measurement by installing the speaker and without performing the re-analysis by setting the analysis condition.

### TECHNICAL FIELD

The present invention relates to a technique of calculating a sound field characteristic of a speaker.

### BACKGROUND TECHNIQUE

Conventionally, as for a car audio, a sound field characteristic in a car by a speaker is calculated. For example, there is disclosed a car audio apparatus mounted on a car which obtains an optimum sound field per car model in Patent Reference-1. Concretely, this technique reads out an equalizer characteristic data per existing speaker based on selection information, and performs an adjustment of an output signal. Additionally, there is disclosed a technique related to the present invention in Patent Reference-2.

Patent Reference-1: Japanese Patent Application Laid-open under No. 2001-301536

Patent Reference-2: Japanese Patent No. 3447888

### DISCLOSURE OF INVENTION

### Problem to be Solved by the Invention

By the way, conventionally, in case of examining a speaker type on a design site, it is generally necessary to attach speakers on an actual car to perform an experiment of a trial listening. For example, as for a small size speaker for a high frequency, since it is easily attached and detached, it is possible to perform the experiment of the trial listening relatively easily. In contrast, as for a medium size speaker or a large size speaker that needs a cabinet for a mid bass or a woofer, it is difficult to perform the experiment of the trial listening for a reason of a weight and a shape. Additionally, in case of analyzing a speaker type by using an analysis, it is also necessary to set an analysis condition at the time of each analysis to perform a re-analysis. Thus, in case of performing the measurement and the analysis of the combination of the plural speaker types and performing the examination, it tends to require an immense amount of time.

In the technique disclosed in above Patent Reference-1, since the combination other than the combination of the pre-set car model and the pre-set speaker type basically requires the re-measurement and the re-analysis, it tends to require a lot of time, too. In Patent Reference-2, there is not disclosed the method for calculating the sound field characteristic in case of using a variety of speakers.

The present invention has been achieved in order to solve the above problem. It is an object of the present invention to provide a speaker characteristic correction device, a speaker characteristic correction method and a speaker characteristic correction program which can easily calculate a sound field characteristic at an evaluation point in case of using a variety of speakers.

### Means for Solving the Problem

In the invention according to claim 1, a speaker characteristic correction device, includes: a first speaker information obtaining unit which obtains a first speaker information of a first speaker; a sound field characteristic obtaining unit which obtains a first sound field characteristic at an evaluation point that is obtained by using the first speaker in advance; a second speaker parameter obtaining unit which obtains a second speaker parameter indicating a mechanical characteristic and an electric characteristic of a second speaker; a correction characteristic calculating unit which calculates a correction characteristic to be applied to the first sound field characteristic in order to calculate a second sound field characteristic of the second speaker, based on the first speaker information and the second speaker parameter; and a correction characteristic applying unit which calculates the second sound field characteristic by applying the correction characteristic to the first sound field characteristic.

In the invention according to claim 15, a speaker characteristic correction method, includes: a first speaker information obtaining process which obtains a first speaker information of a first speaker; a sound field characteristic obtaining process which obtains a first sound field characteristic at an evaluation point that is obtained by using the first speaker in advance; a second speaker parameter obtaining process which obtains a second speaker parameter indicating a mechanical characteristic and an electric characteristic of a second speaker; a correction characteristic calculating process which calculates a correction characteristic to be applied to the first sound field characteristic in order to calculate a second sound field characteristic of the second speaker, based on the first speaker information and the second speaker parameter; and a correction characteristic applying process which calculates the second sound field characteristic by applying the correction characteristic to the first sound field characteristic.

In the invention according to claim 16, a speaker characteristic correction program executed by a computer, making the computer function as: a first speaker information obtaining unit which obtains a first speaker information of a first speaker; a sound field characteristic obtaining unit which obtains a first sound field characteristic at an evaluation point that is obtained by using the first speaker in advance; a second speaker parameter obtaining unit which obtains a second speaker parameter indicating a mechanical characteristic and an electric characteristic of a second speaker; a correction characteristic calculating unit which calculates a correction characteristic to be applied to the first sound field characteristic in order to calculate a second sound field characteristic of the second speaker, based on the first speaker information and the second speaker parameter; and a correction characteristic applying unit which calculates the second sound field characteristic by applying the correction characteristic to the first sound field characteristic.

### BRIEF DESCRIPTION OF THE DRAWINGS

FIG. 1 is a schematic configuration diagram of a car audio according to an embodiment;

FIG. 2 is a control block of a control unit according to a first embodiment;

FIG. 3 is a diagram showing an example of a speaker mounted on a car;

FIGS. 4A and 4B are diagrams for explaining a characteristic change when a speaker is changed;

FIG. 5 is a diagram schematically showing a behavior of a speaker;

FIGS. 6A and 6B are diagrams for explaining a first method for calculating a sound field characteristic;

FIGS. 7A to 7C are diagrams showing examples of an operating condition of a first speaker;

FIGS. 8A and 8B are diagrams showing examples of a diaphragm velocity of a second speaker and a correction curve;

FIG. 9 is a diagram showing an example of a second sound field characteristic calculated by a first method;

FIGS. 10A and 10B are diagrams showing an example of a second sound field characteristic calculated by a second method;

FIG. 11 is a diagram showing an example of a second sound field characteristic calculated by a third method;

FIG. 12 is a diagram showing an example of a second sound field characteristic calculated by a fourth method;

FIG. 13 is a flow chart showing a speaker characteristic correction process according to a first embodiment;

FIG. 14 is a diagram showing an example of a second sound field characteristic calculated by a method according to a modification;

FIG. 15 is a control block of a control unit according to a second embodiment;

FIG. 16 is a flow chart showing a process according to a second embodiment; and

FIG. 17 is a diagram showing an example of a system in which a speaker characteristic correction device is applied to a server.

### BRIEF DESCRIPTION OF THE REFERENCE NUMBER

1 Car Audio

2 Control Unit

2a First Speaker Information Obtaining Unit

2b Sound Field Characteristic Obtaining Unit

2c Second Speaker Parameter Obtaining Unit

2d Correction Characteristic Calculating Unit

2e Correction Characteristic Applying Unit

3 Data Storage Unit

4 Input Unit

5 Reproducing Device

6,15,60 Speaker

### DETAILED DESCRIPTION OF THE PREFERRED EMBODIMENTS

According to one aspect of the present invention, there is provided a speaker characteristic correction device, including: a first speaker information obtaining unit which obtains a first speaker information of a first speaker; a sound field characteristic obtaining unit which obtains a first sound field characteristic at an evaluation point that is obtained by using the first speaker in advance; a second speaker parameter obtaining unit which obtains a second speaker parameter indicating a mechanical characteristic and an electric characteristic of a second speaker; a correction characteristic calculating unit which calculates a correction characteristic to be applied to the first sound field characteristic in order to calculate a second sound field characteristic of the second speaker, based on the first speaker information and the second speaker parameter; and a correction characteristic applying unit which calculates the second sound field characteristic by applying the correction characteristic to the first sound field characteristic.

The above speaker characteristic correction device is preferably used for correcting the sound field characteristic of the speaker used in the car audio. Concretely, the first speaker information obtaining unit obtains the first speaker information, the sound field characteristic obtaining unit obtains the first sound field characteristic at the evaluation point, and the second speaker parameter obtaining unit obtains the second speaker parameter. Then, the correction characteristic calculating unit calculates the correction characteristic (correction curve) to be applied to the first sound field characteristic based on the first speaker information and the second speaker parameter, and the correction characteristic applying unit calculates the second sound field characteristic by applying the correction characteristic to the first sound field characteristic. Namely, when the speaker type is changed, the speaker characteristic correction device calculates the second sound field characteristic by applying the calculated correction characteristic to the results of the preliminary measurement and the preliminary analysis. Thereby, as for the combination of the variety of speakers, it is possible to easily calculate the sound field characteristic without performing the re-measurement by installing the speaker and without performing the re-analysis by setting the analysis condition. In addition, it becomes possible to easily evaluate the characteristic.

In a manner of the above speaker characteristic correction device, the correction characteristic calculating unit calculates the correction characteristic based on a difference between a diaphragm velocity of the first speaker and a diaphragm velocity of the second speaker.

In another manner of the above speaker characteristic correction device, the correction characteristic calculating unit calculates the correction characteristic based on a difference between a voltage of the first speaker and a voltage of the second speaker.

In another manner of the above speaker characteristic correction device, the first speaker information obtaining unit obtains, as the first speaker information, a voltage of the first speaker, a diaphragm velocity of the first speaker and a force that the first speaker receives from a medium. Namely, the first speaker information obtaining unit obtains the operating condition of the first speaker as the first speaker information.

In another manner of the above speaker characteristic correction device, the first speaker information obtaining unit obtains, as the first speaker information, a first speaker parameter indicating a mechanical characteristic and an electric characteristic of the first speaker.

In another manner of the above speaker characteristic correction device, the correction characteristic calculating unit calculates a diaphragm velocity of the first speaker and a diaphragm velocity of the second speaker so as to calculate the correction characteristic, by setting a force that the first speaker receives from a medium and a force that the second speaker receives from a medium to a predetermined value and setting a voltage of the first speaker and a voltage of the second speaker to a predetermined value. In this manner, the speaker characteristic correction device calculates the sound field characteristic without using the operating condition of the first speaker. Thereby, it is possible to reduce the burden of measuring and analyzing the operating condition of the first speaker in advance, and it is possible to calculate the sound field characteristic more easily.

In another manner of the above speaker characteristic correction device, the correction characteristic calculating unit calculates a voltage of the first speaker and a voltage of the second speaker so as to calculate the correction characteristic, by setting a force that the first speaker receives from a medium and a force that the second speaker receives from a medium to a predetermined value and setting a diaphragm velocity of the first speaker and a diaphragm velocity of the second speaker to a predetermined value. Thereby, it is possible to reduce the burden of measuring and analyzing the operating condition of the first speaker in advance, and it is possible to calculate the sound field characteristic more easily, too.

In another manner of the above speaker characteristic correction device, the correction characteristic calculating unit calculates the correction characteristic based on a difference between an area of a diaphragm of the first speaker and an area of a diaphragm of the second speaker. Thereby, it becomes possible to calculate the sound field characteristic with higher accuracy.

In another manner, the above speaker characteristic correction device further includes a display unit which displays the second sound field characteristic calculated by the correction characteristic applying unit. Therefore, by visually judging the second sound field characteristic, it is possible to evaluate the second sound field characteristic.

In another manner, the above speaker characteristic correction device further includes a correction unit which corrects a sound signal by using an equalizer curve based on the second sound field characteristic calculated by the correction characteristic applying unit. Thereby, when the speaker is changed, it becomes possible to easily obtain the optimum sound space.

In another manner, the above speaker characteristic correction device further includes comprising an evaluation unit which evaluates the second speaker based on the second sound field characteristic calculated by the correction characteristic applying unit. In addition, preferably, the correction characteristic applying unit may calculate the second sound field characteristics of plural speakers, and the evaluation unit may determine an optimum speaker from the plural speakers by executing the evaluation based on the second sound field characteristics of the plural speakers calculated by the correction characteristic applying unit.

Preferably, the above speaker characteristic correction device further may include a storage unit which stores the first speaker information, the first sound field characteristic and the second speaker parameter, wherein the first speaker information obtaining unit, the sound field characteristic obtaining unit and the second speaker parameter obtaining unit obtain the first speaker information, the first sound field characteristic and the second speaker parameter from the storage unit, respectively.

Further, preferably, in such a case that a model number of the first speaker is input, the first speaker information obtaining unit may obtain the first speaker information of the first speaker corresponding to the model number from the storage unit, in such a case that a model number of the first speaker and a car model are input, the sound field characteristic obtaining unit may obtain the first sound field characteristic of the first speaker corresponding to the model number and the car model from the storage unit, and in such a case that a model number of the second speaker is input, the second speaker parameter obtaining unit may obtain the second speaker parameter of the second speaker corresponding to the model number from the storage unit.

According to another aspect of the present invention, there is provided a speaker characteristic correction method, including: a first speaker information obtaining process which obtains a first speaker information of a first speaker; a sound field characteristic obtaining process which obtains a first sound field characteristic at an evaluation point that is obtained by using the first speaker in advance; a second speaker parameter obtaining process which obtains a second speaker parameter indicating a mechanical characteristic and an electric characteristic of a second speaker; a correction characteristic calculating process which calculates a correction characteristic to be applied to the first sound field characteristic in order to calculate a second sound field characteristic of the second speaker, based on the first speaker information and the second speaker parameter; and a correction characteristic applying process which calculates the second sound field characteristic by applying the correction characteristic to the first sound field characteristic.

According to still another aspect of the present invention, there is provided a speaker characteristic correction program executed by a computer, making the computer function as: a first speaker information obtaining unit which obtains a first speaker information of a first speaker; a sound field characteristic obtaining unit which obtains a first sound field characteristic at an evaluation point that is obtained by using the first speaker in advance; a second speaker parameter obtaining unit which obtains a second speaker parameter indicating a mechanical characteristic and an electric characteristic of a second speaker; a correction characteristic calculating unit which calculates a correction characteristic to be applied to the first sound field characteristic in order to calculate a second sound field characteristic of the second speaker, based on the first speaker information and the second speaker parameter; and a correction characteristic applying unit which calculates the second sound field characteristic by applying the correction characteristic to the first sound field characteristic.

By the above speaker characteristic correction method and the above speaker characteristic correction program, as for the combination of the variety of speakers, it is possible to easily calculate the sound field characteristic without performing the re-measurement by installing the speaker and without performing the re-analysis by setting the analysis condition, too.

### EMBODIMENT

A preferred embodiment of the present invention will be explained hereinafter with reference to the drawings.

### First Embodiment

First, a description will be given of a first embodiment.

(Device Configuration)

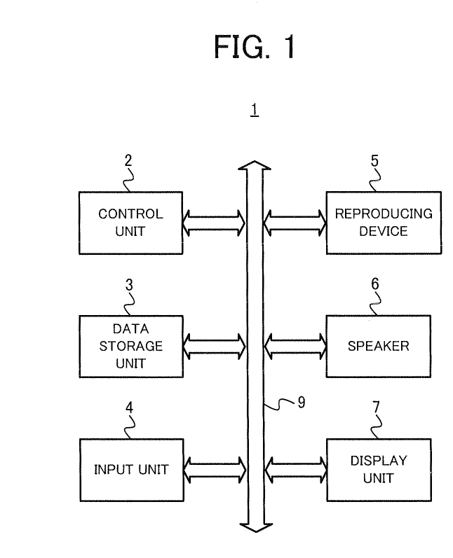

FIG. 1 shows a schematic configuration of a car audio 1 to which a speaker characteristic correction device according to the first embodiment is applied. The car audio 1 mainly includes a control unit 2, a data storage unit 3, an input unit 4, a reproducing device 5, a speaker 6 and a display unit 7.

The control unit 2 includes a CPU (Central Processing Unit) a ROM (Read Only Memory) and a RAM (Random Access Memory), which are not shown, and controls the entire car audio 1. The data storage unit 3 includes HDD, for example, and stores various kinds of data used for a process. The input unit 4 includes keys, switches, buttons and a remote controller, which are used for inputting various kinds of commands and data. Under the control of the control unit 2, the reproducing device 5 reads contents data such as sound data and video data from a disc such as a CD and a DVD to output the contents data.

The speaker 6 includes a tweeter, a mid bass and a woofer, which are not shown, and outputs a sound under the control of the control unit 2. For example, the control unit 2 executes a variety of processes to a sound signal transmitted from the reproducing device 5 via a bus line 9, and the speaker 6 converts the processed sound signal into the sound to output the sound. The display unit 7 displays various kinds of display data under the control of the control unit 2. Concretely, the display unit 7 includes a graphic controller, a buffer memory, a display such as a liquid crystal and a CRT (Cathode Ray Tube) and a drive circuit for driving the display, which are not shown. Additionally, in such a case that the display unit 7 is in a touch panel system, a touch panel provided on the display screen of the display functions as the input unit 4, too.

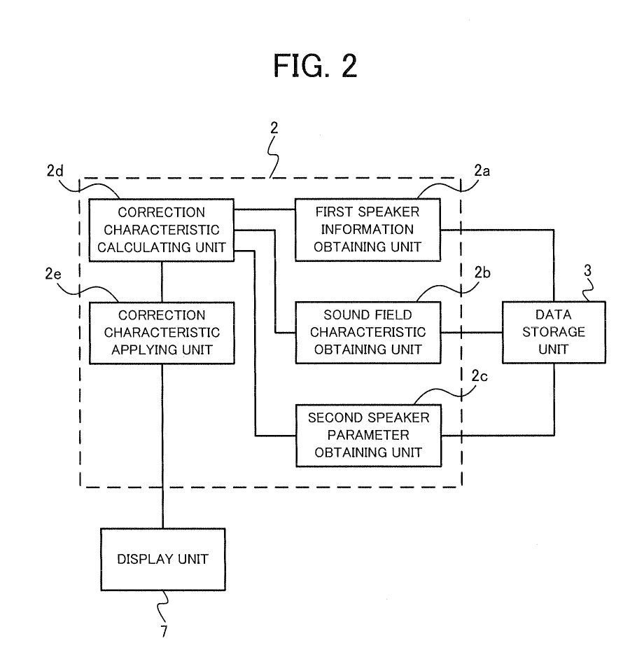

FIG. 2 shows a control block of the control unit 2 according to the first embodiment. As shown in FIG. 2, the control unit 2 includes a first speaker information obtaining unit 2a, a sound field characteristic obtaining unit 2b, a second speaker parameter obtaining unit 2c, a correction characteristic calculating unit 2d and a correction characteristic applying unit 2e.

A brief description will be given of an outline of the process executed by the control unit 2. In such a case that the speaker type used in the car is changed, the control unit 2 mainly executes the process for calculating the sound field characteristic at the evaluation point in case of using the changed speaker. Concretely, the control unit 2 uses the first sound field characteristic that is preliminarily obtained by the measurement and the analysis in case of using the original speaker (it corresponds to the speaker that is preliminarily installed in the car, and it is hereinafter referred to as “first speaker”) so as to calculate the second sound field characteristic of the changed speaker (it is the target speaker for calculating the sound field characteristic, and it is hereinafter referred to as “second speaker”). Namely, the control unit 2 calculates the correction characteristic based on the difference of the operating condition in case of driving the two types of speakers including the first speaker and the second speaker on approximately the same condition, and calculates the second sound field characteristic by applying the correction characteristic to the first sound field characteristic. Specifically, the control unit 2 calculates the correction characteristic to be applied to the first sound field characteristic so as to calculate the second sound field characteristic, based on the first sound field characteristic, the first speaker information of the first speaker and the second speaker parameter of the second speaker. The first sound field characteristic, the first speaker information and the second speaker parameter are stored in the data storage unit 3, for example. In addition, in the data storage unit 3, the first speaker information is stored in association with a model number of the first speaker, and the first sound field characteristic is stored in association with the model number of the first speaker and a car model (for example, sedan, wagon, minivan) for which the measurement and the analysis of the sound field characteristic of the first speaker is performed. Further, in the data storage unit 3, the second speaker parameter is stored in association with a model number of the second speaker.

Thus, the control unit 2 functions as the speaker characteristic correction device. Concretely, the control unit 2 corresponds to the sound field characteristic obtaining unit, the first speaker information obtaining unit, the second speaker parameter obtaining unit, the correction characteristic calculating unit and the correction characteristic applying unit. The data storage unit 3 corresponds to the storage unit.

Concretely, the first speaker information obtaining unit 2a obtains the first speaker information of the first speaker. Specifically, the first speaker information obtaining unit 2a obtains, as the first speaker information, any combination of a first speaker parameter indicating a mechanical characteristic and an electric characteristic of the first speaker, a voltage of the first speaker, a diaphragm velocity of the first speaker and a force that the first speaker receives from a medium (hereinafter, the voltage, the diaphragm velocity and the receiving force from the medium are collectively referred to as “operating condition”), which is required for calculating the correction characteristic. In this case, the first speaker information obtaining unit 2a obtains the first speaker information from the input unit 4 or the data storage unit 3. Namely, the first speaker information obtaining unit 2a obtains the first speaker information that is directly input by the user via the input unit 4, or obtains the first speaker information that is preliminarily stored in the data storage unit 3. In such a case that the model number of the first speaker is input by the user, the first speaker information obtaining unit 2a obtains the first speaker information corresponding to the model number from the data storage unit 3.

The sound field characteristic obtaining unit 2b obtains the first sound field characteristic at the evaluation point (the predetermined point in the car compartment) that is preliminarily measured and analyzed by using the first speaker. Concretely, the sound field characteristic obtaining unit 2b obtains the first sound field characteristic from the input unit 4 or the data storage unit 3. Namely, the sound field characteristic obtaining unit 2b obtains the first sound field characteristic that is directly input by the user via the input unit 4, or obtains the first sound field characteristic that is preliminarily stored in the data storage unit 3. In such a case that the model number of the first speaker and the car model (for example, sedan, wagon, minivan) are input by the user, the sound field characteristic obtaining unit 2b obtains the first sound field characteristic corresponding to the model number and the car model from the data storage unit 3.

The second speaker parameter obtaining unit 2c obtains the second speaker parameter indicating the mechanical characteristic and the electric characteristic of the second speaker. Concretely, the second speaker parameter obtaining unit 2c obtains the second speaker parameter from the input unit 4 or the data storage unit 3. Namely, the second speaker parameter obtaining unit 2c obtains the second speaker parameter that is directly input by the user via the input unit 4, or obtains the second speaker parameter that is stored in the data storage unit 3. In such a case that the model number of the second speaker is input by the user, the second speaker parameter obtaining unit 2c obtains the second speaker parameter corresponding to the model number from the data storage unit 3.

The correction characteristic calculating unit 2d calculates the correction characteristic (hereinafter referred to as “correction curve”) to be applied to the first sound field characteristic in order to calculate the second sound field characteristic, based on the first speaker information obtained by the first speaker information obtaining unit 2a and the second speaker parameter obtained by the second speaker parameter obtaining unit 2c. Concretely, the correction characteristic calculating unit 2d calculates the correction curve based on the difference between the voltage of the first speaker and the voltage of the second speaker or the difference between the diaphragm velocity of the first speaker and the diaphragm velocity of the second speaker. Namely, the correction characteristic calculating unit 2d calculates the correction curve as a correction filter to be applied to the first sound field characteristic, based on the difference of the voltage or the difference of the diaphragm velocity in case of driving the two types of speakers including the first speaker and the second speaker on approximately the same condition.

The correction characteristic applying unit 2e calculates the second sound field characteristic by applying the correction curve calculated by the correction characteristic calculating unit 2d to the first sound field characteristic. The calculated second sound field characteristic is displayed on the display unit 7.

According to the above-mentioned process, when the speaker type is changed, by applying the calculated correction curve to the results of the preliminary measurement and the preliminary analysis, it is possible to easily calculate the sound field characteristic without performing the re-measurement by installing the speaker and without performing the re-analysis by setting the analysis condition. Therefore, by applying the calculated sound field characteristic to the original sound field characteristic, as for the combination of the variety of speakers, it becomes possible to easily evaluate the characteristic with taking the actual sound field into account. Concretely, if the first sound field characteristic is measured and analyzed per the plural car models, and the first sound field characteristic is stored in the data storage unit 3, it is possible to easily calculate the sound field characteristic in case of applying the variety of speakers to the plural car models, and it becomes possible to evaluate the sound field characteristic.

The control unit 2 can execute the process other than the above-mentioned process. For example, the control unit 2 can correct a sound signal by using an equalizer curve based on the calculated second sound field characteristic. Therefore, when the speaker in the car is changed, it becomes possible to easily obtain an optimum sound space.

Further, it is not limited that the car audio 1 includes the display unit 7. Namely, it is not limited that the calculated second sound field characteristic is displayed on the display unit 7. In this case, the car audio 1 performs the correction of the sound signal by using the equalizer curve based on the second sound field characteristic without displaying the second sound field characteristic.

(Fundamental Principle)

Next, a description will be given of a fundamental principle of a method for calculating the above sound field characteristic.

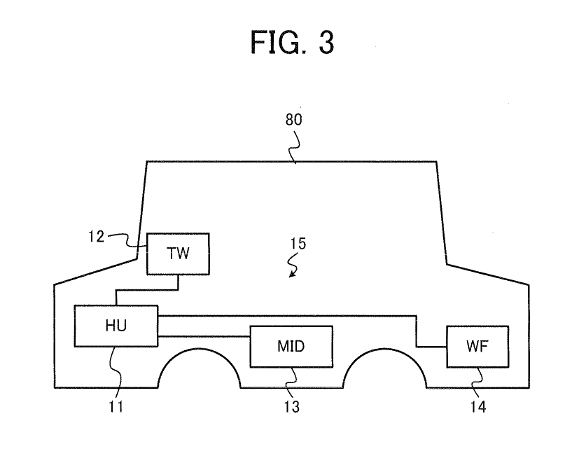

FIG. 3 shows an example of the speaker mounted on the car 80. As shown in FIG. 3, a head unit 11 is installed in the car 80, and a tweeter (TW) 12, a mid bass (MID) 13 and a woofer (WF) 14 are installed as a speaker 15. The head unit 11 executes a variety of processes to a sound signal that is read out from such as a CD or a DVD, and outputs a sound signal to each of the tweeter 12, the mid bass 13 and the woofer 14. For example, the head unit 11 includes a reproducing device which reproduces such as the CD or the DVD and a DSP (Digital Signal Processor) which processes the sound signal. The head unit 11 corresponds to the above control unit 2.

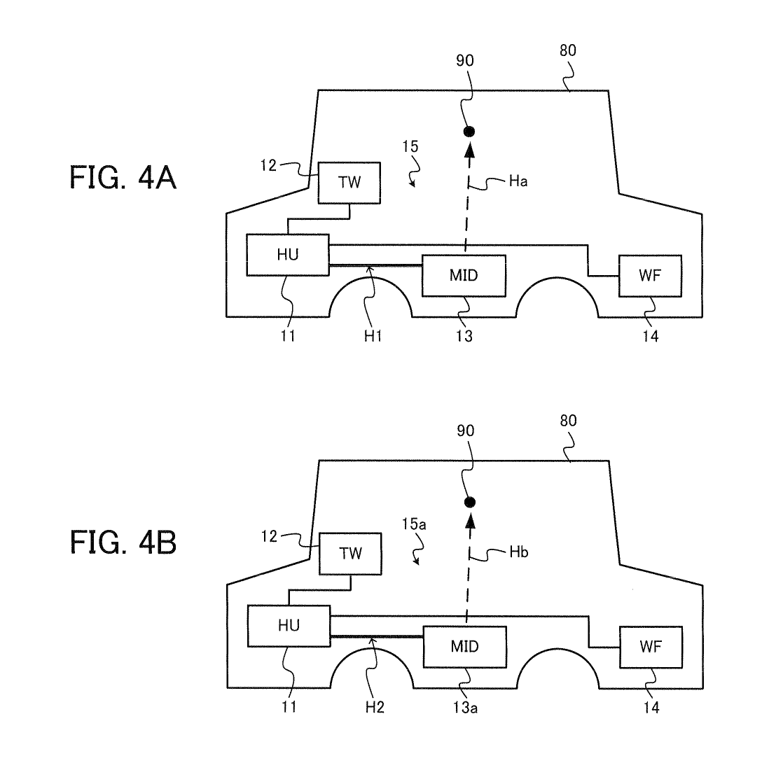

FIGS. 4A and 4B are diagrams for explaining a characteristic change when the speaker is changed. Concretely, FIG. 4A shows the same diagram as FIG. 3, and FIG. 4B shows a diagram in case of changing the mid bass 13 shown in FIG. 4A to a mid bass 13a. Namely, the speaker 15 shown in FIG. 4A corresponds to the first speaker, and the speaker 15a shown in FIG. 4B corresponds to the second speaker. Additionally, in FIGS. 4A and 4B, a point shown by a reference numeral 90 shows the evaluation point (listening position). It is assumed that the first sound field characteristic at the evaluation point 90 in case of using the speaker 15 is obtained by the preliminary measurement and the preliminary analysis. Further, it is assumed that the speaker information (the first speaker information) of the speaker 15 is obtained.

When the speaker is changed (i.e., when the mid bass 13 is changed to the mid bass 13a) as described above, it is understood that a transfer characteristic Hb from the mid bass 13a to the evaluation point 90 is little different from a transfer characteristic Ha from the original mid bass 13 to the evaluation point 90. Meanwhile, it is understood that a transfer characteristic H2 from the head unit 11 to the mid bass 13a is different from a transfer characteristic H1 from the head unit 11 to the mid bass 13. The characteristic H1, H2 are defined by a mechanical characteristic and an electric characteristic from the head unit 11 to the mid basses 13 and 13a.

Consequently, when the speaker is changed as described above, it can be said that it is possible to easily perform the transformation from the characteristic H1 into the characteristic H2 by providing the speaker parameter of the new speaker 15a. Therefore, by providing the speaker parameter of the new speaker 15a and utilizing the information corresponding to the transfer characteristic Ha of the original speaker 15, it is understood that it is possible to easily calculate the sound field characteristic of the speaker 15a without performing the re-measurement and the re-analysis by using the speaker 15a. Namely, since the sound field characteristic of the original speaker 15 and the speaker information of the original speaker 15 are preliminarily obtained as described above, by providing the parameter of the new speaker 15a, it is possible to easily calculate the sound field characteristic of the new speaker 15a based on these.

According to the above principle, the control unit 2 calculates the correction curve based on the first speaker information and the second speaker parameter, and applies the correction curve to the first sound field characteristic so as to calculate the second sound field characteristic. Namely, the control unit 2 calculates the correction curve to be applied to the first sound field characteristic so as to calculate the second sound field characteristic, based on the difference of the voltage or the difference of the diaphragm velocity in case of driving the two types of speakers (the first speaker and the second speaker) on approximately the same condition. In this case, it can be said that the difference of the voltage between the first speaker and the second speaker or the difference of the diaphragm velocity between the first speaker and the second speaker approximately corresponds to the difference between the characteristic H1 and the characteristic H2. So, it can be said that calculating the correction curve based on the difference of the voltage or the difference of the diaphragm velocity and applying the correction curve to the first sound field characteristic corresponds to performing the transformation from the characteristic H1 into the characteristic H2 and calculating the sound field characteristic of the speaker 15a.

If an optimum equalizer curve in case of using the speaker 15 is preliminarily calculated, according to the above principle, it can be said that it is possible to use the equalizer curve when the speaker 15 is changed to the speaker 15a. Therefore, when the speaker in the car is changed, it becomes possible to easily obtain an optimum sound space.

(Method for Calculating Sound Field Characteristic)

Next, a description will be given of a concrete example of a method for calculating the sound field characteristic performed by the above control unit 2 (in details, the correction characteristic calculating unit 2d and the correction characteristic applying unit 2e).

The meaning of the characters and the signs described later are as follows.

i Current

V Voltage (Speaker Terminal Voltage)

ud Vibration Velocity Of Diaphragm (Diaphragm Velocity)

F Receiving Force From Medium

Re DC Resistance

Le Inductance

A Force Coefficient

Rm Mechanical Resistance

Mo Equivalent Mass

So Stiffness

Ze Electric Impedance

Zm Mechanical Impedance

S Area of Diaphragm

### (A) First Method

First, a description will be given of a first method for calculating the sound field characteristic. In the first method, the correction curve is calculated by the difference between the diaphragm velocity of the first speaker and the diaphragm velocity of the second speaker based on the first speaker information and the second speaker parameter, and the second sound field characteristic is calculated by applying the correction curve to the first sound field characteristic. Concretely, the control unit 2 uses the operating condition (the voltage, the diaphragm velocity and the receiving force from the medium) of the first speaker as the first speaker information, and calculates the correction curve by the difference of the diaphragm velocity between the first speaker and the second speaker based on the operating condition and the second speaker parameter.

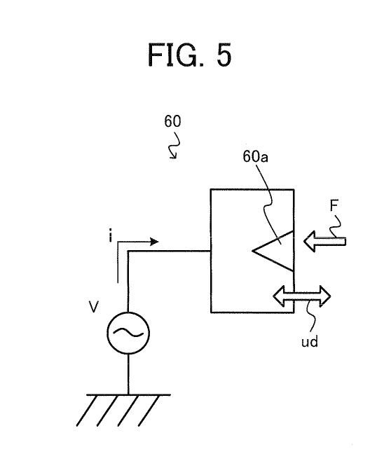

A description will be given of a basic behavior of the speaker, with reference to FIG. 5. FIG. 5 schematically shows the behavior of the speaker. As shown in FIG. 5, the current of the speaker 60 (corresponding to the above speaker 6, 15) is i, and the voltage of the speaker 60 is V. The diaphragm 60a receives the force F from the medium and vibrates at the velocity ud. In this case, the balance of the electric system of the speaker 60 is expressed by the equation (1), and the balance of the mechanical system is expressed by the equation (2).

Ze·i+A·ud=V (1)

−A·i+Zm·ud=−F (2)

“Ze” in the equation (1) is expressed by the equation (3), and “Zm” in the equation (2) is expressed by the equation (4).

Ze·Re+jωLe (3)

$$Zm = Rm + j ( ω Mo - \frac{So}{ω} ) \qquad ( 4 )$$

By the equation (1) and the equation (2), the voltage V (the speaker terminal voltage) of the speaker 60 is expressed by the following equation (5).

$$V = ( A + Ze \cdot \frac{Zm}{A} ) \cdot ud + F \cdot \frac{Ze}{A} \qquad ( 5 )$$

By the equation (1) and the equation (2), the diaphragm velocity ud of the speaker 60 is expressed by the following equation (6).

$$ud = \frac{A \cdot V - Ze \cdot F}{{A}^{2} + Ze \cdot Zm} \qquad ( 6 )$$

The DC resistance Re, the inductance Le, the force coefficient A, the mechanical resistance Rm, the equivalent mass Mo, the stiffness So, the electric impedance Ze and the mechanical impedance Zm in the above equation are treated as the speaker parameter. Generally, the speaker parameter can be obtained by the measurement of the electric impedance characteristic. Actually, the DC resistance Re, the force coefficient A, the mechanical resistance Rm, the equivalent mass Mo and the stiffness So are calculated by the resonance characteristic around f0. Additionally, the inductance Le is calculated by the high frequency characteristic of the electric impedance. Further, the electric impedance Ze and the mechanical impedance Zm are calculated by the equation (3) and the equation (4), respectively. The above-mentioned speaker parameter is stored in the above data storage unit 3. Even if the speaker parameter is not calculated as described above, the speaker parameter is sometimes described as a specification in a commercially available speaker unit.

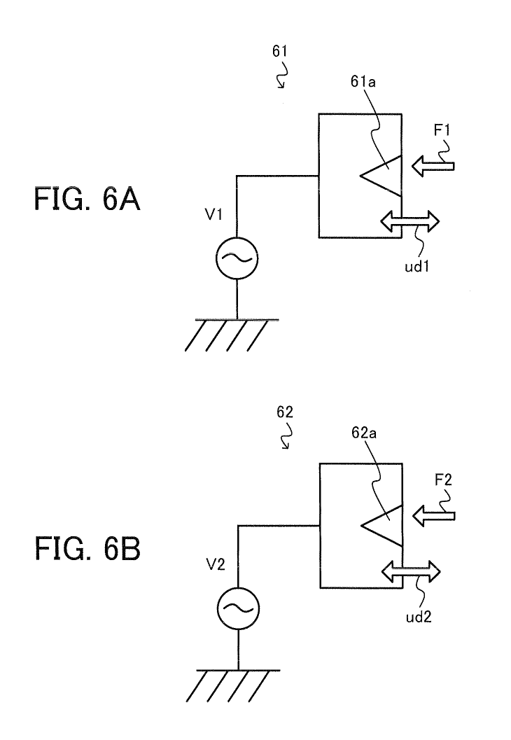

FIGS. 6A and 6B are diagrams for concretely explaining the first method for calculating the sound field characteristic. FIG. 6A shows a schematic diagram of an original speaker 61 before changing the speaker, and FIG. 6B shows a schematic diagram of a speaker 62 after changing the speaker. Namely, the speaker 61 corresponds to the first speaker, and the speaker 62 corresponds to the second speaker. Hereinafter, the speaker 61 is referred to as “first speaker”, and the speaker 62 is referred to as “second speaker”. In this case, the voltage of the first speaker is V1, and the diaphragm 61a vibrates at the velocity ud1 by receiving the force F1 from the medium. Additionally, the voltage of the second speaker is V2, and the diaphragm 62a vibrates at the velocity ud2 by receiving the force F2 from the medium.

When the speaker is changed as described above, the control unit 2 calculates the correction curve by the difference between the diaphragm velocity ud1 of the first speaker and the diaphragm velocity ud2 of the second speaker based on the first speaker information and the second speaker parameter, and calculates the second sound field characteristic by applying the correction curve to the first sound field characteristic. Concretely, first, the control unit 2 obtains, as the first speaker information, the voltage V1, the diaphragm velocity ud1 and the receiving force F1 from the medium (these correspond to the operating condition of the first speaker).

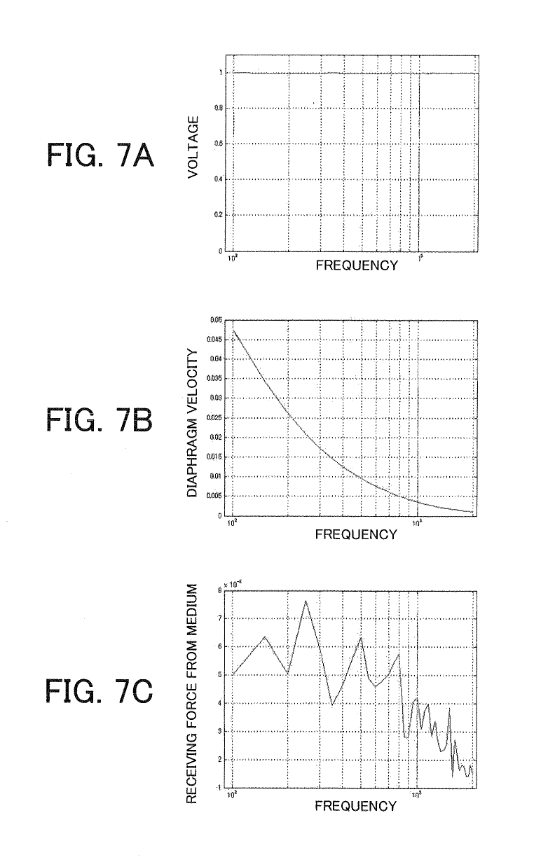

FIGS. 7A to 7C show examples of the obtained operating condition of the first speaker. Concretely, FIG. 7A shows the voltage V1, and FIG. 7B shows the diaphragm velocity ud1, and FIG. 7C shows the receiving force F1 from the medium.

In addition, the control unit 2 obtains the first sound field characteristic at the evaluation point that is preliminarily measured and analyzed by using the first speaker. Further, the control unit 2 obtains, as the second speaker parameter, the force coefficient A2, the electric impedance Ze2 and the mechanical impedance Zm2. Then, the control unit 2 calculates the diaphragm velocity ud2 of the second speaker by the following equation (7), based on the obtained first speaker information and the obtained second speaker parameter as described above.

$$ud 2 = \frac{A 2 \cdot V 1 - Ze 2 \cdot F 1}{A {2}^{2} + Ze 2 \cdot Zm 2} \qquad ( 7 )$$

Concretely, the control unit 2 calculates the diaphragm velocity ud2 of the second speaker by substituting, into the equation (7), the voltage V1 and the receiving force F1 from the medium, which are included in the first speaker information, and the force coefficient A2, the electric impedance Ze2 and the mechanical impedance Zm2, which are included in the second speaker parameter. Then, the control unit 2 calculates the correction curve by the difference between the diaphragm velocity ud1 of the first speaker and the diaphragm velocity ud2 of the second speaker based on the following equation (8).

Correction Curve=20×log 10(ud2/ud1) (8)

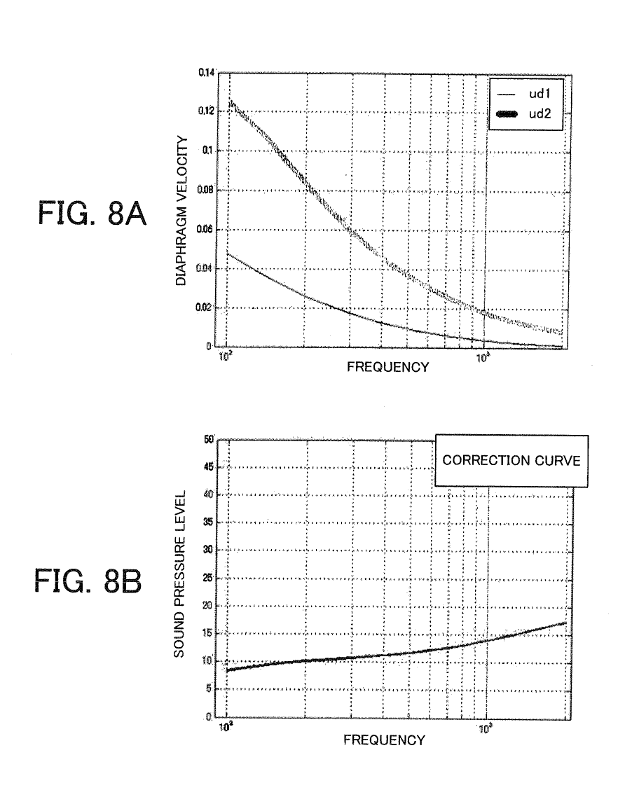

FIGS. 8A and 8B show examples of the calculated diaphragm velocity ud2 of the second speaker and the calculated correction curve as described above. Concretely, FIG. 8A shows the diaphragm velocity ud1 of the first speaker and the diaphragm velocity ud2 of the second speaker, and FIG. 8B shows the correction curve.

Next, the control unit 2 calculates the second sound field characteristic by applying the calculated correction curve to the first sound field characteristic.

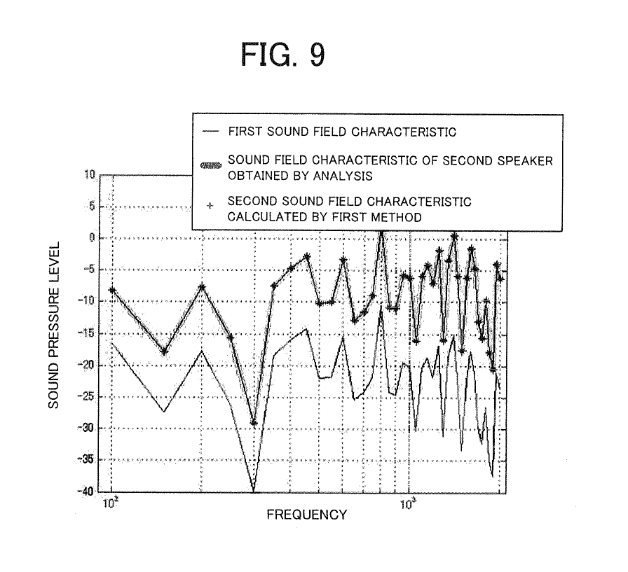

FIG. 9 shows an example of the second sound field characteristic calculated by the first method. Concretely, FIG. 9 shows the original first sound field characteristic, the second sound field characteristic of the second speaker obtained by the actual analysis and the second sound field characteristic calculated by the first method. As shown in FIG. 9, it can be understood that the second sound field characteristic calculated by the first method approximately coincides with the second sound field characteristic obtained by actually analyzing the second speaker. Namely, by the first method, it can be said that it is possible to calculate the second sound field characteristic with high accuracy. In addition, the result shown in FIG. 9 can be displayed on the display unit 7 by the control unit 2. Therefore, when the speaker is changed, it becomes possible to easily compare the changed sound field characteristic with the original sound field.

Thus, by the first method, when the speaker type is changed, it is possible to calculate the sound field characteristic with high accuracy and easily calculate the sound field characteristic.

### (B) Second Method

Next, a description will be given of a second method for calculating the sound field characteristic. In the second method, the correction curve is calculated by the difference between the voltage V1 of the first speaker and the voltage V2 of the second speaker based on the first speaker information and the second speaker parameter, and the second sound field characteristic is calculated by applying the correction curve to the first sound field characteristic. Namely, though the correction curve is calculated based on the difference of the diaphragm velocity in the first method, the correction curve is calculated based on the difference of the voltage instead of the difference of the diaphragm velocity in the second method.

Concretely, first, the control unit 2 obtains, as the first speaker information, the voltage V1, the diaphragm velocity ud1 and the receiving force F1 from the medium (these correspond to the operating condition of the first speaker). For example, the control unit 2 obtains the operating condition as shown in FIGS. 7A to 7C. In addition, the control unit 2 obtains the first sound field characteristic at the evaluation point that is preliminarily measured and analyzed by using the first speaker. Further, the control unit 2 obtains, as the second speaker parameter, the force coefficient A2, the electric impedance Ze2 and the mechanical impedance Zm2. Then, the control unit 2 calculates the voltage V2 of the second speaker by the following equation (9), based on the obtained first speaker information and the obtained second speaker parameter as described above.

$$V 2 = ( A 2 + Ze 2 \cdot \frac{Zm 2}{A 2} ) \cdot ud 1 + F 1 \cdot \frac{Ze 2}{A 2} \qquad ( 9 )$$

Concretely, the control unit 2 calculates the voltage V2 of the second speaker by substituting, into the equation (9), the diaphragm velocity ud1 and the receiving force F1 from the medium, which are included in the first speaker information, and the force coefficient A2, the electric impedance Ze2 and the mechanical impedance Zm2, which are included in the second speaker parameter. Then, the control unit 2 calculates the correction curve by the difference between the voltage V1 of the first speaker and the voltage V2 of the second speaker based on the following equation (10).

Correction Curve=20×log 10(V1/V2) (10)

Next, the control unit 2 calculates the second sound field characteristic by applying the calculated correction curve to the first sound field characteristic.

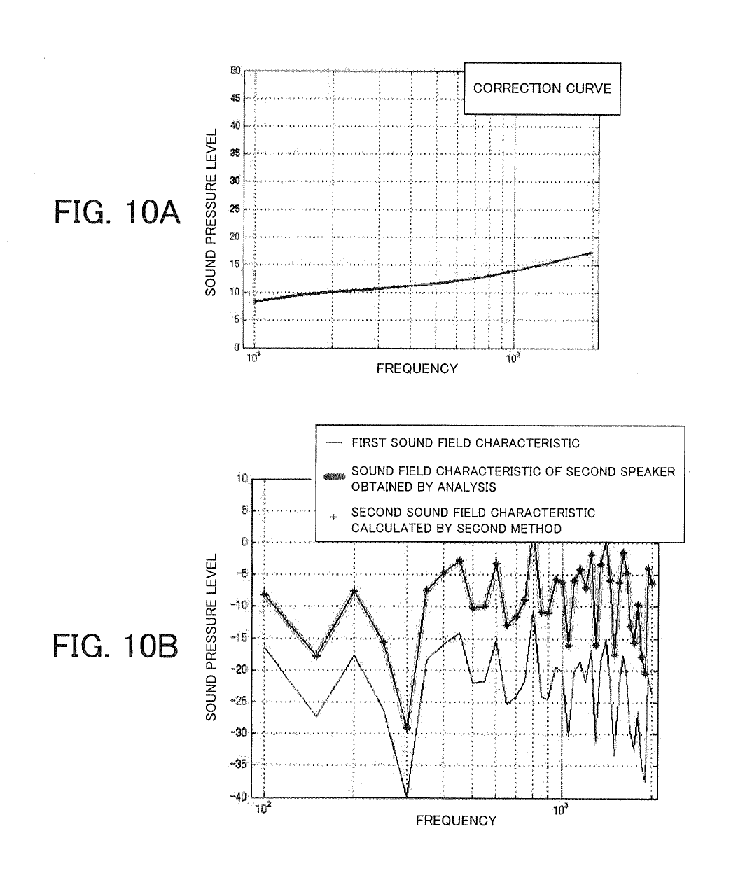

FIGS. 10A and 10B show examples of the correction curve and the second sound field characteristic calculated by the second method. Concretely, FIG. 10A shows the correction curve. FIG. 10B shows the original first sound field characteristic, the second sound field characteristic of the second speaker obtained by the actual analysis and the second sound field characteristic calculated by the second method. As shown in FIG. 10B, it can be understood that the second sound field characteristic calculated by the second method approximately coincides with the second sound field characteristic obtained by actually analyzing the second speaker. Namely, by the second method, it can be said that it is possible to calculate the second sound field characteristic with high accuracy, too. In addition, the result shown in FIG. 10B can be displayed on the display unit 7 by the control unit 2.

Thus, by the second method, when the speaker type is changed, it is possible to calculate the sound field characteristic with high accuracy and easily calculate the sound field characteristic, too.

### (C) Third Method

Next, a description will be given of a third method for calculating the sound field characteristic. In the third method, the first speaker parameter indicating the mechanical characteristic and the electric characteristic of the first speaker is used as the first speaker information, and the correction curve is calculated based on the first speaker parameter and the second speaker parameter. Namely, though the operating condition (the voltage V1, the diaphragm velocity ud1 and the receiving force F1 from the medium) of the first speaker is used as the first speaker information in the first method and the second method, the correction curve is calculated by using the first speaker parameter as the first speaker information without using the operating condition of the first speaker in the third method. In the third method, the correction curve is calculated by the difference between the diaphragm velocity of the first speaker and the diaphragm velocity of the second speaker based on the first speaker parameter and the second speaker parameter, and the second sound field characteristic is calculated by applying the correction curve to the first sound field characteristic.

Concretely, first, the control unit 2 obtains, as the first speaker information, the force coefficient A1, the electric impedance Ze1 and the mechanical impedance Zm1 (these correspond to the first speaker parameter). In addition, the control unit 2 obtains the first sound field characteristic at the evaluation point that is preliminarily measured and analyzed by using the first speaker. Further, the control unit 2 obtains, as the second speaker parameter, the force coefficient A2, the electric impedance Ze2 and the mechanical impedance Zm2.

Then, the control unit 2 calculates the diaphragm velocities ud1 and ud2 by setting the receiving forces F1 and F2 from the medium and the voltages V1 and V2 to the predetermined value, respectively. For example, the control unit 2 sets the receiving forces F1 and F2 as “F1=F2=0” and sets the voltages V1 and V2 as “V1=V2=1”, and calculates the diaphragm velocity ud1 of the first speaker and the diaphragm velocity ud2 of the second speaker. Concretely, the control unit 2 calculates the diaphragm velocity ud1 and the diaphragm velocity ud2 by the following equations (11) and (12).

$$\begin{matrix}ud 1 = \frac{A 1 \cdot V 1 - Ze 1 \cdot F 1}{A {1}^{2} + Ze 1 \cdot Zm 1} & ( 11 ) \\ ud 2 = \frac{A 2 \cdot V 2 - Ze 2 \cdot F 2}{A {2}^{2} + Ze 2 \cdot Zm 2} & ( 12 )\end{matrix}$$

Next, the control unit 2 calculates the correction curve by the difference between the diaphragm velocity ud1 of the first speaker and the diaphragm velocity ud2 of the second speaker based on the above equation (8). Then, the control unit 2 calculates the second sound field characteristic by applying the calculated correction curve to the first sound field characteristic.

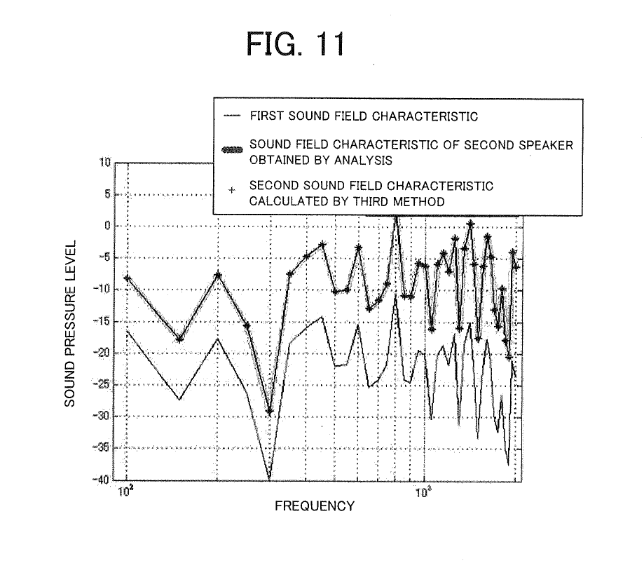

FIG. 11 shows an example of the second sound field characteristic calculated by the third method. Concretely, FIG. 11 shows the original first sound field characteristic, the second sound field characteristic of the second speaker obtained by the actual analysis and the second sound field characteristic calculated by the third method. As shown in FIG. 11, it can be understood that the second sound field characteristic calculated by the third method approximately coincides with the second sound field characteristic obtained by actually analyzing the second speaker. Namely, by the third method, it can be said that it is possible to calculate the second sound field characteristic with high accuracy, too. In addition, the result shown in FIG. 11 can be displayed on the display unit 7 by the control unit 2.

Thus, by the third method, since the sound field characteristic can be calculated without using the operating condition of the first speaker, it is possible to reduce the burden of measuring and analyzing the operating condition of the first speaker in advance. Therefore, the third method can calculate the sound field characteristic more easily than the first method and the second method. Additionally, since the second sound field characteristic calculated by the third method approximately coincides with the second sound field characteristic obtained by actually analyzing the second speaker as shown in FIG. 11, it can be said that it is possible to obtain the satisfactory accuracy by the simplified method.

### (D) Fourth Method

Next, a description will be given of a fourth method for calculating the sound field characteristic. In the fourth method, like the third method, the first speaker parameter is used as the first speaker information, and the correction curve is calculated based on the first speaker parameter and the second speaker parameter. Namely, the correction curve is calculated by using the first speaker parameter without using the operating condition (the voltage V1, the diaphragm velocity ud1 and the receiving force F1 from the medium) of the first speaker. Though the correction curve is calculated based on the difference of the diaphragm velocity in the third method, the correction curve is calculated based on the difference of the voltage instead of the difference of the diaphragm velocity in the fourth method.

Concretely, first, the control unit 2 obtains, as the first speaker information, the force coefficient A1, the electric impedance Ze1 and the mechanical impedance Zm1 (these correspond to the first speaker parameter). In addition, the control unit 2 obtains the first sound field characteristic at the evaluation point that is preliminarily measured and analyzed by using the first speaker. Further, the control unit 2 obtains, as the second speaker parameter, the force coefficient A2, the electric impedance Ze2 and the mechanical impedance Zm2.

Then, the control unit 2 calculates the voltages V1 and V2 by setting the receiving forces F1 and F2 from the medium and the diaphragm velocities ud1 and ud2 to the predetermined value, respectively. For example, the control unit 2 sets the receiving forces F1 and F2 as “F1=F2=0” and the diaphragm velocities ud1 and ud2 as “ud1=ud2=1”, and calculates the voltage V1 of the first speaker and the voltage V2 of the second speaker. Concretely, the control unit 2 calculates the voltage V1 and the voltage V2 by the following equations (13) and (14).

$$\begin{matrix}V 1 = ( A 1 + Ze 1 \cdot \frac{Zm 1}{A 1} ) \cdot ud 1 + F 1 \cdot \frac{Ze 1}{A 1} & ( 13 ) \\ V 2 = ( A 2 + Ze 2 \cdot \frac{Zm 2}{A 2} ) \cdot ud 2 + F 2 \cdot \frac{Ze 2}{A 2} & ( 14 )\end{matrix}$$

Next, the control unit 2 calculates the correction curve by the difference between the voltage V1 of the first speaker and the voltage V2 of the second speaker based on the above equation (10). Then, the control unit 2 calculates the second sound field characteristic by applying the calculated correction curve to the first sound field characteristic.

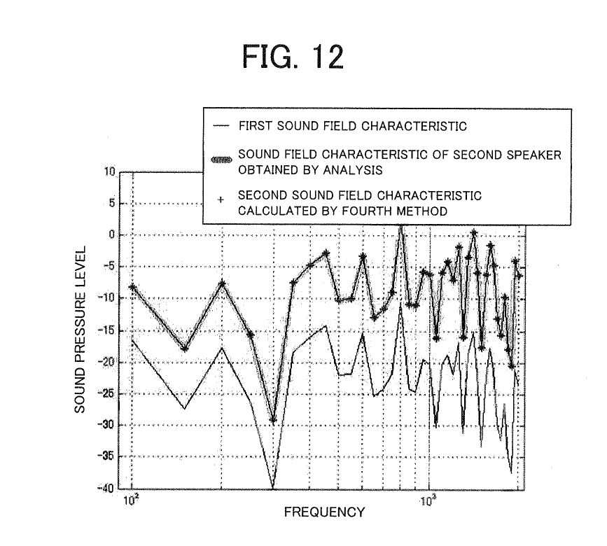

FIG. 12 shows an example of the second sound field characteristic calculated by the fourth method. Concretely, FIG. 12 shows the original first sound field characteristic, the sound field characteristic of the second speaker obtained by the actual analysis and the second sound field characteristic calculated by the fourth method. As shown in FIG. 12, it can be understood that the second sound field characteristic calculated by the fourth method approximately coincides with the second sound field characteristic obtained by actually analyzing the second speaker. Namely, by the fourth method, it can be said that it is possible to calculate the second sound field characteristic with high accuracy, too. In addition, the result shown in FIG. 12 can be displayed on the display unit 7 by the control unit 2.

Thus, by the fourth method, since the sound field characteristic can be calculated without using the operating condition of the first speaker, it is possible to reduce the burden of measuring and analyzing the operating condition of the first speaker in advance. Therefore, the fourth method can calculate the sound field characteristic more easily than the first method and the second method. Additionally, since the second sound field characteristic calculated by the fourth method approximately coincides with the second sound field characteristic obtained by actually analyzing the second speaker as shown in FIG. 12, it can be said that it is possible to obtain the satisfactory accuracy by the simplified method.

(Speaker Characteristic Correction Process)

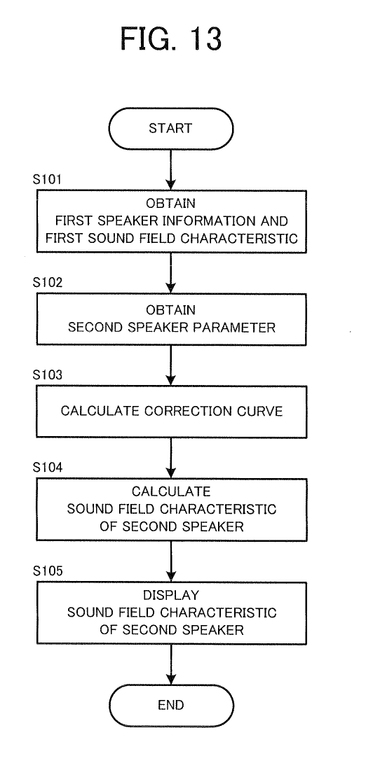

Next, a description will be given of a speaker characteristic correction process executed by the control unit 2, with reference to FIG. 13. FIG. 13 is a flow chart showing the speaker characteristic correction process according to the first embodiment.

First, in step S101, the control unit 2 obtains the first speaker information and the first sound field characteristic. Concretely, the first speaker information obtaining unit 2a in the control unit 2 obtains, as the first speaker information, any combination of the first speaker parameter and the operating condition of the first speaker, which is required for calculating the correction characteristic. Specifically, the first speaker information obtaining unit 2a obtains the operating condition of the first speaker in case of executing the first method or the second method, or obtains the first speaker parameter in case of executing the third method or the fourth method. Meanwhile, the sound field characteristic obtaining unit 2b in the control unit 2 obtains the first sound field characteristic at the evaluation point that is preliminarily measured and analyzed by using the first speaker. The first speaker information obtaining unit 2a and the sound field characteristic obtaining unit 2b obtain the first speaker information and the first sound field characteristic from the input unit 4 or the data storage unit 3, respectively. Namely, the first speaker information obtaining unit 2a and the sound field characteristic obtaining unit 2b obtain the information that is directly input by the user via the input unit 4, or obtain the information that is preliminarily stored in the data storage unit 3. Further, in such a case that the model number of the first speaker and the car model are input by the user, the first speaker information obtaining unit 2a obtains the first speaker information corresponding to the model number from the data storage unit 3, and the sound field characteristic obtaining unit 2b obtains the first sound field characteristic corresponding to the model number and the car model from the data storage unit 3. When the above process ends, the process goes to step S102.

In step S102, the control unit 2 obtains the second speaker parameter indicating the mechanical characteristic and the electric characteristic of the second speaker. Concretely, the second speaker parameter obtaining unit 2c in the control unit 2 obtains the second speaker parameter from the input unit 4 or the data storage unit 3. Namely, the second speaker parameter obtaining unit 2c obtains the second speaker parameter that is directly input by the user via the input unit 4, or obtains the second speaker parameter that is stored in the data storage unit 3. In such a case that the model number of the second speaker is input by the user, the second speaker parameter obtaining unit 2c obtains the second speaker parameter corresponding to the model number from the data storage unit 3. When the above process ends, the process goes to step S103.

In step S103, the control unit 2 calculates the correction curve to be applied to the first sound field characteristic in order to calculate the second sound field characteristic, based on the first speaker information obtained in step S101 and the second speaker parameter obtained in step S102. Concretely, the correction characteristic calculating unit 2d in the control unit 2 calculates the correction curve based on the difference between the voltage of the first speaker and the voltage of the second speaker or the difference between the diaphragm velocity of the first speaker and the diaphragm velocity of the second speaker. Specifically, in case of executing the first method or the second method, the correction characteristic calculating unit 2d calculates the diaphragm velocity or the voltage of the second speaker by the equation (7) or the equation (9). In contrast, in case of executing the third method or the fourth method, the correction characteristic calculating unit 2d calculates the diaphragm velocities or the voltages of each of the first speaker and the second speaker by the equations (11) and (12) or the equations (13) and (14). Then, the correction characteristic calculating unit 2d calculates the correction curve by the equation (8) based on the difference of the diaphragm velocity in case of executing the first method or the third method, or calculates the correction curve by the equation (10) based on the difference of the voltage in case of executing the second method or the fourth method. When the above process ends, the process goes to step S104.

In step S104, the control unit 2 calculates the second sound field characteristic by applying the correction curve calculated in step S103 to the first sound field characteristic. Then, the process goes to step S105. In step S105, the control unit 2 executes the process for displaying the second sound field characteristic calculated in step S104 on the display unit 7. When the above process ends, the process goes out of the flow.

According to the above-mentioned speaker characteristic correction process, when the speaker type is changed, by applying the calculated correction curve to the results of the preliminary measurement and the preliminary analysis, it is possible to easily calculate the sound field characteristic without performing the re-measurement by installing the speaker and without performing the re-analysis by setting the analysis condition. Therefore, by applying the calculated sound field characteristic to the original sound field characteristic, as for the combination of the variety of car models and the variety of speaker types, it becomes possible to easily evaluate the characteristic with taking the actual sound field into account.

(Modification)

In the above first method to fourth method, the correction curve to be applied to the first sound field characteristic is calculated so as to calculate the second sound field characteristic, based on the difference of the voltage or the difference of the diaphragm velocity between the first speaker and the second speaker. In the modification, the correction curve can be calculated so as to calculate the second sound field characteristic, in consideration of not only the difference of the voltage or the difference of the diaphragm velocity but also a difference between an area of the diaphragm of the first speaker and an area of the diaphragm of the second speaker. Concretely, in the method according to the modification, by using both the correction curve calculated by any one of the first method to the fourth method and the correction curve calculated by the difference of the area of the diaphragm between the first speaker and the second speaker, the second sound field characteristic is calculated by correcting the first sound field characteristic.

Specifically, in such a case that the area of the diaphragm of the first speaker is defined as “S1” and the area of the diaphragm of the second speaker is defined as “S2”, the above control unit 2 calculates the correction curve by the following equation (15).

Correction Curve=20×log 10(S2/S1) (15)

The equation (15) expresses that the correction curve is calculated by the difference between the area S1 of the diaphragm of the first speaker and the area S2 of the diaphragm of the second speaker. Then, the control unit 2 calculates the second sound field characteristic by using both the correction curve calculated by the equation (15) and the correction curve calculated by any one of the first method to the fourth method.

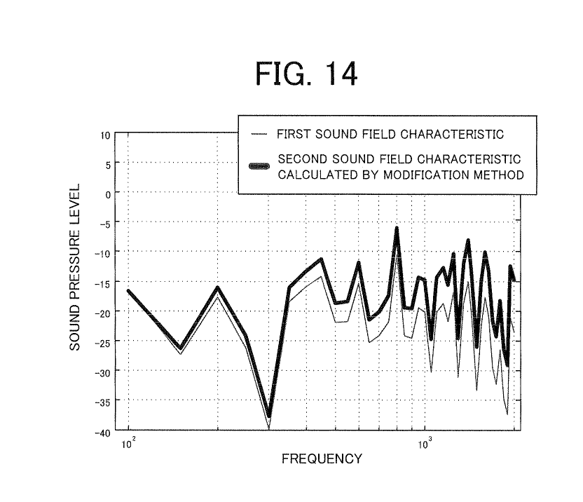

FIG. 14 shows an example of the second sound field characteristic calculated by the method according to the modification. Concretely, FIG. 14 shows the original first sound field characteristic and the second sound field characteristic calculated by the method according to the modification. Specifically, the second sound field characteristic corresponds to the sound field characteristic which is calculated by applying, to the first sound field characteristic, both the correction curve calculated by any one of the first method to the fourth method and the correction curve calculated by the difference of the area of the diaphragm between the first speaker and the second speaker. By the method according to the modification, it becomes possible to calculate the sound field characteristic with higher accuracy.

In such a case that the speakers are operated on the same condition, by only using the difference of the area of the diaphragm between the first speaker and the second speaker without using the difference of the voltage and the difference of the diaphragm velocity, it is possible to calculate the correction curve so as to calculate the second sound field characteristic.

### Second Embodiment

Next, a description will be given of a second embodiment. The second embodiment is different from the first embodiment in that the calculated second sound field characteristic as described above is evaluated. Concretely, in the second embodiment, the second sound field characteristics of the plural second speakers are calculated, and the optimum speaker is determined from the plural second speakers by evaluating the calculated plural second sound field characteristics.

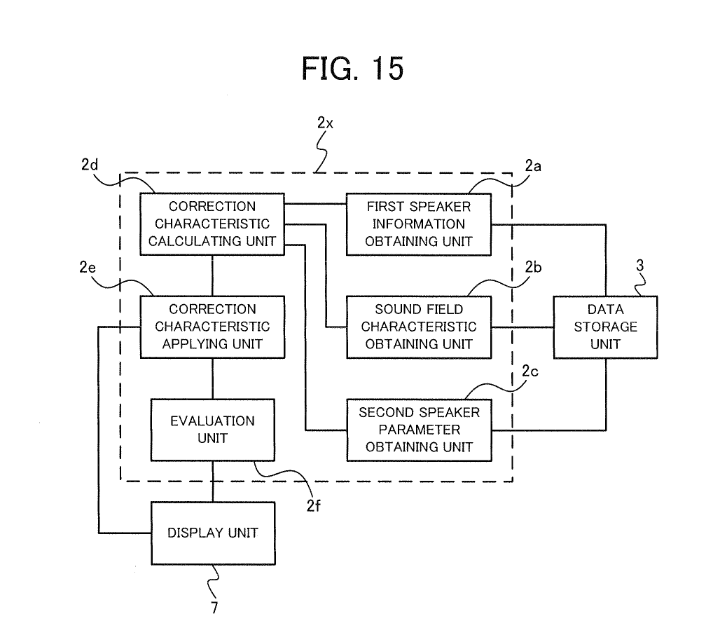

FIG. 15 shows a control block of a control unit 2x according to the second embodiment. The same reference numerals are given to the same components as those of the above control unit 2 according to the first embodiment (see FIG. 2), and explanations thereof are omitted. The control unit 2x is also applied to the car audio 1.

The control unit 2x according to the second embodiment is different from the control unit 2 according to the first embodiment in that an evaluation unit 2f is included. The evaluation unit 2f evaluates the second sound field characteristic calculated by the correction characteristic applying unit 2e. Concretely, the evaluation unit 2f determines the optimum speaker from the plural second speakers by evaluating the plural second sound field characteristics. For example, the evaluation unit 2f preliminarily sets a desired characteristic of the sound field characteristic, and determines the optimum speaker by using a residual between the desired characteristic and the second sound field characteristic as an evaluation value. Further, the evaluation unit 2f makes the display unit 7 display the information of the determined optimum speaker.

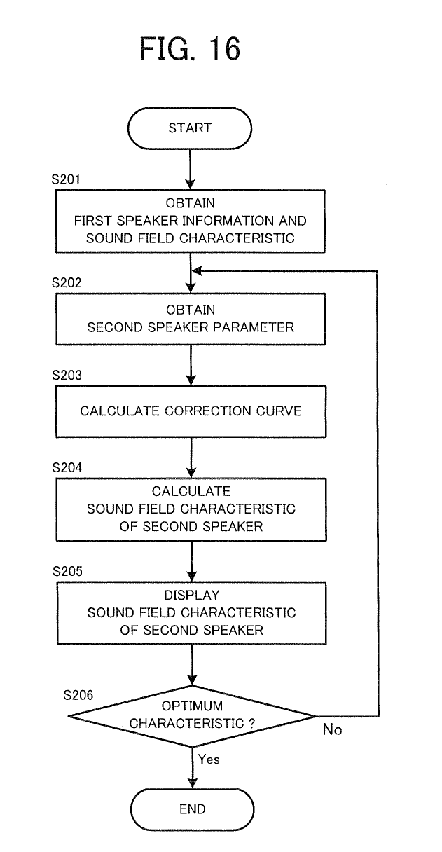

FIG. 16 is a flow chart showing a process according to the second embodiment. The process is executed by inputting an initial condition of a target car model in order to evaluate the sound field characteristics with taking the first sound field characteristic at the original evaluation point into account, while the second speaker is changed more than once, thereby to determine the optimum speaker. Additionally, the process is executed by the control unit 2x.

Since the processes in steps S201 to S205 are similar to the above processes in steps S101 to S105 (see FIG. 13), explanations thereof are omitted. In step S206, the control unit 2x evaluates the second sound field characteristic calculated in step S205. Concretely, the evaluation unit 2f in the control unit 2x determines whether or not the second sound field characteristic is optimum. For example, the evaluation unit 2f uses, as the evaluation value, the residual between the pre-set desired characteristic and the second sound field characteristic, and compares the evaluation value calculated this time with the evaluation value previously calculated so as to execute the determination. When the control unit 2x determines that the second sound field characteristic is optimum (step S206; Yes), the process goes out of the flow. In this case, the speaker corresponding to the second sound field characteristic for which the process is executed this time is determined as the optimum speaker, for example. In contrast, when the control unit 2x determines that the second sound field characteristic is not optimum (step S206; No), the process goes back to step S202. In this case, the control unit 2x executed the processes in steps S202 to S206 with respect to a new second speaker. Namely, the control unit 2x calculates the second sound field characteristic of the new second speaker to evaluate the second sound field characteristic.

By the above second embodiment, it becomes possible to appropriately and easily determine the optimum speaker from the plural speakers. Therefore, it becomes possible to automatize an optimum design of the speaker.

Thus, the control unit in the car audio functions as: the first speaker information obtaining unit which obtains the first speaker information of a first speaker; the sound field characteristic obtaining unit which obtains the first sound field characteristic at the evaluation point that is obtained by using the first speaker in advance; the second speaker parameter obtaining unit which obtains the second speaker parameter indicating the mechanical characteristic and the electric characteristic of the second speaker; the correction characteristic calculating unit which calculates the correction characteristic to be applied to the first sound field characteristic in order to calculate a second sound field characteristic of the second speaker, based on the first speaker information and the second speaker parameter; and the correction characteristic applying unit which calculates the second sound field characteristic by applying the correction characteristic to the first sound field characteristic. Therefore, when the speaker type is changed, it becomes possible to easily calculate the sound field characteristic.

It is assumed that the above process is executed by the control units 2 and 2x executing the preliminary prepared program (speaker characteristic correction program). Instead, the above process may be executed by a hardware process of a circuit. In addition, the speaker characteristic correction program may be preliminarily stored in a ROM in the control units 2 and 2x. The speaker characteristic correction program may be provided from outside by a recording medium such as a CD or a DVD on which the program is recorded, and the program read out by the reproducing device 5 may be stored in the ROM.

### APPLICATION EXAMPLE

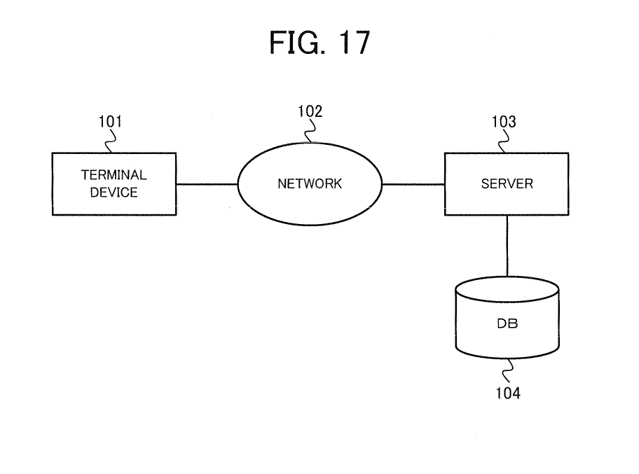

In the above embodiment, the speaker characteristic correction device of the present invention is applied to the car audio. Instead, the speaker characteristic correction device of the present invention can be applied to a server. FIG. 17 shows an example of a system in which the speaker characteristic correction device of the present invention is applied to a server 103. In this case, a terminal device 101 is connected to the server 103 via a network 102 such as Internet. In addition, the server 103 is connected to DB (Data Base) 104. In this case, the server 103 has the similar function as the above control units 2 and 2x. Concretely, the server 103 functions as the sound field characteristic obtaining unit, the first speaker information obtaining unit, the second speaker parameter obtaining unit, the correction characteristic calculating unit and the correction characteristic applying unit. Additionally, in the DB 104, the first sound field characteristic, the first speaker information and the second speaker parameter are stored. For example, in the DB 104, the first speaker information is stored in association with the model number of the first speaker, and the first sound field characteristic is stored in association with the model number of the first speaker and the car model that is performed the measurement and the analysis of the sound field characteristic of the first speaker. Further, in the DB 104, the second speaker parameter is stored in association with the model number of the second speaker.

A description will be given of a method for utilization of the above system. The user inputs, into the terminal device 101, the information of the speaker presently mounted on the car and the information of the second speaker that the user wants to examine the sound field characteristic. Concretely, the user directly inputs the first sound field characteristic, the first speaker information and the second speaker parameter, or inputs the model numbers of the first speaker and the second speaker and the car model. The server 103 obtains the information input by the user via the network 102. In such a case that the model number of the speaker and the car model are input by the user, the server 103 obtains the first sound field characteristic corresponding to the model number of the first speaker and the car model, obtains the first speaker information corresponding to the model number of the first speaker, and obtains the second speaker parameter corresponding to the model number of the second speaker, by searching in the DB 104.

Afterward, the server 103 calculates the correction curve based on the obtained first speaker information and the obtained second speaker parameter, and calculates the second sound field characteristic by applying the correction curve to the first sound field characteristic. Then, the server 103 provides the calculated the second sound field characteristic to the terminal device 101 via the network 102, and makes the terminal device 101 display the second sound field characteristic. Further, in such a case that the user inputs the information of the plural second speakers, the server 103 calculates the second sound field characteristics of the plural second speakers, and determines the optimum speaker from the plural second speakers by evaluating the second sound field characteristics. In this case, the server 103 provides the information of the determined optimum speaker to the terminal device 101 via the network 102, and makes the terminal device 101 display the information, too.

Thus, the system in which the speaker characteristic correction device is applied to a server 103 can be used for a speaker characteristic evaluation service and a speaker install tool. Thereby, as for the combination of the variety of car models and the variety of speaker types, it is possible to provide the sound field characteristic and evaluate the sound field characteristic without performing the re-measurement by installing the speaker and without performing the re-analysis by setting the analysis condition.

In the above application example, such an example that the speaker characteristic correction device is applied to a server 103 is shown. Instead, the speaker characteristic correction device may be applied to a terminal device. In this case, a CPU in the terminal device executes the similar process as the above control units 2 and 2x, and the first sound field characteristic, the first speaker information and the second speaker parameter are stored in a hard disk in the terminal device.

In addition, it is not limited that the above speaker characteristic correction device is applied to the speaker installed in the car compartment. Besides the speaker installed in the car compartment, if the sound field characteristic is obtained in case of using the original speaker in the predetermined space, the speaker characteristic correction device can calculate the sound field characteristic of the changed speaker by using the sound field characteristic in case of changing the original speaker. For example, the above speaker characteristic correction device can be applied to an amplifier in a home. Namely, when the speaker in the home is changed, it is also possible to calculate the sound field characteristic of the changed speaker. In this case, it is possible to appropriately correct the sound signal by using the equalizer curve used by the original speaker.

Further, the above speaker characteristic correction device can be used for a speaker analysis tool and a design support tool of a speaker. In such a case that a variety of speakers are used, and in such a case that a speaker is installed in a variety of environments, it is possible to easily calculate the sound field characteristic without performing the re-measurement by installing the speaker and without performing the re-analysis by setting the analysis condition, and it is possible to easily perform the analysis.

In the above embodiment, while such an example that the correction curve is calculated by using “log” is shown (see the equations (8), (10) and (15)), it is not limited to this. In the above embodiment, by calculating the correction curve in the form of “log”, the correction curve is expressed by the unit of “dB”. In another embodiment, the correction curve can be calculated without using “log”. Concretely, in such a case that the correction curve is expressed by the unit of “N/m²”, the correction curve can be calculated in the form before applying “log”. For example, by using the diaphragm velocity ud1 of the first speaker and the diaphragm velocity ud2 of the second speaker, the correction curve can be calculated by the following equation (16).

Correction Curve=ud2/ud1 (16)

Namely, the correction curve can be calculated by using the equation (16) instead of the above equation (8). Similarly, instead of the above equation (10), the correction curve can be calculated by an equation expressed without using “log”, based on the voltage V1 of the first speaker and the voltage V2 of the second speaker. In addition, instead of the above equation (15), the correction curve can be calculated by an equation expressed without using “log”, based on the area S1 of the diaphragm of the first speaker and the area S2 of the diaphragm of the second speaker. In such a case that the correction curve is calculated in the form before applying “log” as described above, the correction curve becomes the complex number. Thereby, it is also possible to consider the phase.

For example, in such a case that the first sound field characteristic is expressed by the unit of “N/m²” (i.e., expressed by the complex number), by calculating the correction curve without using “log” as described above, it is possible to directly apply the correction curve to the first sound field characteristic. In this case, the second sound field characteristic expressed by the complex number is obtained. By executing the calculation to the obtained second sound field characteristic by using “log”, the second sound field characteristic expressed by the unit of “dB” which is similar to the above second sound field characteristic (see FIG. 9) is obtained.

### INDUSTRIAL APPLICABILITY

This invention can be used for a speaker install tool, a speaker characteristic evaluation service, a speaker analysis tool and a design support tool of a speaker, by calculating a sound field characteristic of a speaker at an evaluation point.

1. A speaker characteristic correction device comprising:
a first speaker information obtaining unit which obtains a first speaker information that indicates data including a voltage of a first speaker, a diaphragm velocity of the first speaker and a force that the first speaker receives from a medium, or data including a mechanical characteristic and an electric characteristic of the first speaker;
a sound field characteristic obtaining unit which obtains a first sound field characteristic at an evaluation point that is obtained by using the first speaker in advance;
a second speaker parameter obtaining unit which obtains a second speaker parameter indicating a mechanical characteristic and an electric characteristic of a second speaker;
a correction characteristic calculating unit which calculates a correction characteristic to be applied to the first sound field characteristic in order to calculate a second sound field characteristic of the second speaker, based on the first speaker information and the second speaker parameter; and
a correction characteristic applying unit which calculates the second sound field characteristic by applying the correction characteristic to the first sound field characteristic.

2. The speaker characteristic correction device according to claim 1,
wherein the correction characteristic calculating unit calculates the correction characteristic based on a difference between the diaphragm velocity of the first speaker and a diaphragm velocity of the second speaker.

3. The speaker characteristic correction device according to claim 1,
wherein the correction characteristic calculating unit calculates the correction characteristic based on a difference between the voltage of the first speaker and a voltage of the second speaker.

4. The speaker characteristic correction device according to claim 1,
wherein the first speaker information obtaining unit obtains, as the first speaker information, the voltage of the first speaker, the diaphragm velocity of the first speaker and the force that the first speaker receives from the medium.

5. The speaker characteristic correction device according to claim 1,
wherein the first speaker information obtaining unit obtains, as the first speaker information, a first speaker parameter indicating the mechanical characteristic and an electric characteristic of the first speaker.

6. The speaker characteristic correction device according to claim 5,
wherein the correction characteristic calculating unit calculates the diaphragm velocity of the first speaker and a diaphragm velocity of the second speaker so as to calculate the correction characteristic, by setting the force that the first speaker receives from the medium and a force that the second speaker receives from a medium to a predetermined value and setting the voltage of the first speaker and a voltage of the second speaker to a predetermined value.

7. The speaker characteristic correction device according to claim 5,
wherein the correction characteristic calculating unit calculates the voltage of the first speaker and the voltage of the second speaker so as to calculate the correction characteristic, by setting the force that the first speaker receives from a medium and a force that the second speaker receives from a medium to a predetermined value and setting the diaphragm velocity of the first speaker and a diaphragm velocity of the second speaker to a predetermined value.

8. The speaker characteristic correction device according to claim 1,
wherein the correction characteristic calculating unit calculates the correction characteristic based on a difference between an area of a diaphragm of the first speaker and an area of a diaphragm of the second speaker.

9. The speaker characteristic correction device according to claim 1, further comprising a display unit which displays the second sound field characteristic calculated by the correction characteristic applying unit.

10. The speaker characteristic correction device according to claim 1, further comprising a correction unit which corrects a sound signal by using an equalizer curve based on the second sound field characteristic calculated by the correction characteristic applying unit.

11. The speaker characteristic correction device according to claim 1, further comprising an evaluation unit which evaluates the second speaker based on the second sound field characteristic calculated by the correction characteristic applying unit.

12. The speaker characteristic correction device according to claim 11,
wherein the correction characteristic applying unit calculates the second sound field characteristics of plural speakers, and
wherein the evaluation unit determines an optimum speaker from the plural speakers by executing the evaluation based on the second sound field characteristics of the plural speakers calculated by the correction characteristic applying unit.

13. The speaker characteristic correction device according to claim 1, further comprising a storage unit which stores the first speaker information, the first sound field characteristic and the second speaker parameter,
wherein the first speaker information obtaining unit, the sound field characteristic obtaining unit and the second speaker parameter obtaining unit obtain the first speaker information, the first sound field characteristic and the second speaker parameter from the storage unit, respectively.

14. The speaker characteristic correction device according to claim 13,
wherein, in such a case that a model number of the first speaker is input, the first speaker information obtaining unit obtains the first speaker info illation of the first speaker corresponding to the model number from the storage unit,
wherein, in such a case that a model number of the first speaker and a car model are input, the sound field characteristic obtaining unit obtains the first sound field characteristic of the first speaker corresponding to the model number and the car model from the storage unit, and
wherein, in such a case that a model number of the second speaker is input, the second speaker parameter obtaining unit obtains the second speaker parameter of the second speaker corresponding to the model number from the storage unit.

15. A speaker characteristic correction method comprising:
a first speaker information obtaining process which obtains a first speaker information that indicates data including a voltage of a first speaker, a diaphragm velocity of the first speaker and a fore that the first speaker receives from a medium, or data including a mechanical characteristic of the first speaker;
a sound field characteristic obtaining process which obtains a first sound field characteristic at an evaluation point that is obtained by using the first speaker in advance;
a second speaker parameter obtaining process which obtains a second speaker parameter indicating a mechanical characteristic and an electric characteristic of a second speaker;
a correction characteristic calculating process which calculates a correction characteristic to be applied to the first sound field characteristic in order to calculate a second sound field characteristic of the second speaker, based on the first speaker information and the second speaker parameter; and
a correction characteristic applying process which calculates the second sound field characteristic by applying the correction characteristic to the first sound field characteristic.

16. A computer program product in a computer-readable medium executed by a speaker characteristic correction device comprising a computer, making the computer function as:
a first speaker information obtaining unit which obtains a first speaker information that indicates data including a voltage of a first speaker, a diaphragm velocity of the first speaker and a force that the first speaker receives from a medium, or data including a mechanical characteristic and an electric characteristic of the first speaker;
a sound field characteristic obtaining unit which obtains a first sound field characteristic at an evaluation point that is obtained by using the first speaker in advance;
a second speaker parameter obtaining unit which obtains a second speaker parameter indicating a mechanical characteristic and an electric characteristic of a second speaker;
a correction characteristic calculating unit which calculates a correction characteristic to be applied to the first sound field characteristic in order to calculate a second sound field characteristic of the second speaker, based on the first speaker information and the second speaker parameter; and
a correction characteristic applying unit which calculates the second sound field characteristic by applying the correction characteristic to the first sound field characteristic.
